(19) United States
(12) Patent Application Publication
(10) Pub. No.: US 2003/0213825 A1
(43) Pub. Date: Nov. 20, 2003

(54) Storage pouch for use with a bicycle

(76) Inventor: Kiersten Ruthann Hale, Mission Viejo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/147,122

(22) Filed: May 15, 2002

(51) Int. Cl. B62J 7/06; B62J 9/00; B62J 11/00

(52) U.S. Cl. 224/421; 224/426; 224/463

(57) ABSTRACT

A storage pouch is configured to be removably attached to a top tube, a head tube and a down tube of a bicycle. The storage pouch preferably includes a base member and a roof member. The roof member has a roof member perimeter, a portion of which is attached to the base member, thereby forming a partially enclosed compartment between the base member and the roof member. The storage pouch preferably includes top tube connectors affixed to the base member or the roof member, and extending from the base member or the roof member around the top tube of the bicycle. The storage pouch preferably includes down tube connectors affixed to a portion of the storage pouch, and extending therefrom around the down tube of the bicycle. The storage pouch preferably includes head tube connectors affixed to the base member or the roof member, and extending from the base member or the roof member around the head tube of the bicycle.

### BACKGROUND OF THE INVENTION

1. Field of the Invention

The present invention relates generally to storage containers, and relates particularly to storage containers capable of being removably attached to a bicycle.

2. Description of the Related Art

Both professional and recreational cyclists often need to carry a wide variety of items during competitive or recreational cycling events. Examples of such items include foodstuffs, water, bicycle tools, maps, first aid materials, currency, house or automobile keys, and mobile telephones. In particular, many cyclists find it extremely valuable to carry a mobile telephone. A mobile telephone can be used to summon aid in the event of an accident or a mechanical failure, to report the progress of a bicycle ride to others, to check the status of inclement weather, or to stay in contact with other people while cycling.

Although it is often desirable to carry all of the aforementioned items during a cycling event, doing so can be inconvenient for the cyclist. Such items can be bulky and difficult to store in traditional storage pouches, which are generally either strapped to the cyclist or to the bicycle. Furthermore, carrying a large number of items increases the weight of the cyclist and/or bicycle, thereby decreasing the cyclist's efficiency. In addition, a storage pouch containing a large number of items can be difficult and inconvenient to sort through. Finally, carrying a large number of items can increase the cyclist's wind resistance. Therefore, it is desirable to have an apparatus for carrying some or all of the aforementioned items that makes a minimal contribution to the cyclist's weight and wind resistance.

In addition, traditional storage pouches often cause the cyclist great inconvenience when s/he wishes to access the storage pouch contents. For example, storage pouches are often stowed under the saddle. Although positioning a storage pouch under the saddle minimizes detrimental effects on wind resistance, this location is extremely inconvenient for the cyclist. If the cyclist wishes to access the contents of an under-the-saddle storage pouch while riding the bicycle, s/he will generally be forced to stop riding and dismount the bicycle. In the context of a bicycle race, or even a recreational bicycle ride, where the keeping of a constant pace and cadence is critical, such a stop and dismount would be extremely detrimental to the cyclist's progress.

Another traditional location for storing items during a cycling event is in a pouch located at the back of the cyclist's jersey. Storing items in this location minimizes detrimental effect on wind resistance, and does not require the cyclist to dismount to access the stored items. However, accessing items stored in a pouch in the back of the cyclist's jersey generally requires the cyclist to leave the aerodynamic “tuck” position in which the cyclist leans forward over the handlebar (or “areobar”) to reduce wind resistance. Again, in the context of a bicycle race, or even a recreational bicycle ride, leaving the tuck position is extremely detrimental to the cyclist's progress. Furthermore, accessing items stored in a pouch in the back of the cyclist's jersey requires the cyclist to put his/her hand a great distance from the handlebar, and to twist around on the saddle while still operating the bicycle. Additionally, items carried in a pouch located at the back of the cyclist's jersey are susceptible to shifting or other movement during cycling, thereby distracting the cyclist's attention with concern that such items may fall out of the pouch. Any time the cyclist's attention is removed from the operation of the bicycle, a safety hazard is created.

Other traditional storage pouches are configured to be hung from or otherwise attached to the top tube of the bicycle. An example of such a storage pouch is disclosed in U.S. Pat. No. 5,862,965 to Nakahara. While storing items in this location can minimize detrimental effects on the bicycle's wind resistance, this pouch will often come in contact with the cyclist's knees during pedaling action. In addition, storage pouches that attach to the top tube without also attaching to the down tube will not be securely attached to the bicycle. Specifically, the rough and rigorous movements common to mountain biking require that any items attached to a mountain bike be attached in a secure fashion (i.e., be attached to both the top tube and the down tube) to prevent shifting during bicycle rides.

In light of the foregoing, it is desirable to have a bicycle storage pouch capable of carrying objects such as a mobile telephone, automobile or house keys, foodstuffs, maps, currency, or other objects. It is desirable that such a storage pouch not substantially increase the weight or wind resistance of the cyclist or bicycle. Additionally, it is desirable to have a bicycle storage pouch that can be easily accessed by the cyclist without necessitating interruption of the cyclist's cadence, and without distracting the cyclist from his/her safe operation of the bicycle. Furthermore, it is desirable to have a storage pouch that holds items in a secure manner while traversing rough terrain, such as during mountain biking. Finally, it is desirable to have a bicycle storage pouch that does not interfere with actions the cyclist may take while riding, such as pedaling, changing gears, or braking. The storage pouch described herein addresses all of these desires.

### SUMMARY OF THE INVENTION

According to one aspect of the present invention, a storage pouch configured to be removably attached to a top tube, a head tube and a down tube of a bicycle comprises a base member and a roof member. The roof member has a roof member perimeter, a portion of which is attached to the base member, thereby forming a partially enclosed compartment between the base member and the roof member. The storage pouch further comprises a top tube connector affixed to the base member or the roof member, and extending from the base member or the roof member around the top tube of the bicycle. The storage pouch further comprises a down tube connector affixed to a portion of the storage pouch and extending therefrom around the down tube of the bicycle. The storage pouch further comprises a head tube connector affixed to the base member or the roof member, and extending from the base member or the roof member around the head tube of the bicycle.

According to another aspect of the present invention, a method of receiving an incoming telephone call on a mobile telephone comprises positioning the mobile telephone within a storage pouch secured to a bicycle. The storage pouch has a transparent window configured to allow a display portion of the mobile telephone to be viewed by a bicycle rider without removing the mobile telephone from the storage pouch. The method further comprises viewing the display portion of the mobile telephone upon receipt of the incoming telephone call, and deciding whether to answer the incoming telephone call based upon that information.

According to another aspect of the present invention, a multifunction pouch comprises a horizontal storage compartment positioned atop a top tube of a bicycle. The multifunction pouch further comprises at least one vertical storage compartment connected to the horizontal storage compartment, the vertical storage compartment positioned aside the top tube of the bicycle. The multifunction pouch further comprises at least two connectors securing the horizontal and vertical pouches to the bicycle.

### BRIEF DESCRIPTION OF THE DRAWINGS

The illustrative embodiments described herein may be best described with reference to the accompanying drawings. All drawings are for ease of explanation of the basic teachings of the illustrative embodiments only; the extensions of the drawings with respect to number, position, relationship and dimensions of the parts to form the preferred embodiment will be explained or will be within the skill of one of ordinary skill in the art after the following description has been read and understood. Further, the exact dimensions and dimensional proportions to conform to specific force, weight, strength, and similar requirements will likewise be within the skill of one of ordinary skill in the art after the following description has been read and understood.

FIG. 1 is a perspective view of a bicycle having one embodiment of a storage pouch removably attached thereto.

FIG. 2 is a detail perspective view of the storage pouch of FIG. 1 shown on the front portion of a bicycle.

FIG. 3 is a perspective view of one embodiment of the storage pouch of FIG. 1 after removal from the bicycle.

FIG. 4 is a cross-sectional view of the base member of the storage pouch of FIG. 1.

### DETAILED DESCRIPTION OF THE PREFERRED EMBODIMENTS

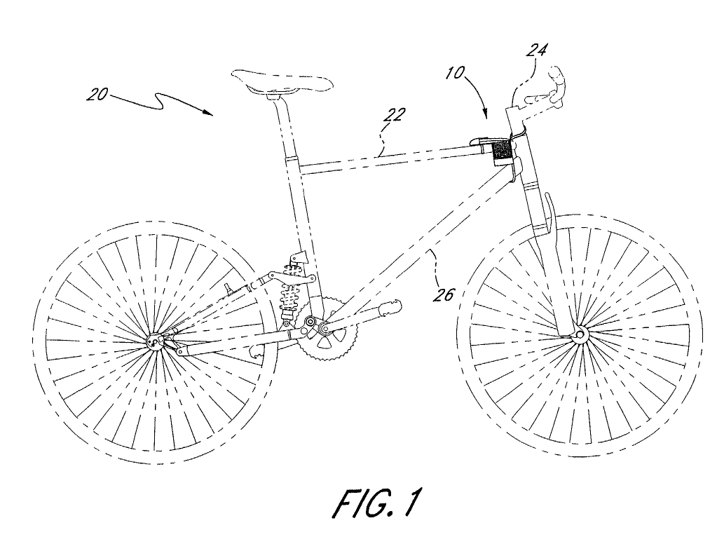

FIGS. 1 through 3 illustrate one embodiment of a storage pouch 10 configured to be removably attached to a top tube 22, a head tube 24 and a down tube 26 of a bicycle 20. The storage pouch 10 preferably includes a base member 30 and a roof member 40. The roof member 40 has a roof member perimeter 42, a portion of which is attached to the base member 30, thereby forming a partially enclosed compartment 50 between the base member 30 and the roof member 40. The storage pouch 10 preferably includes top tube connectors 108, 110 affixed to the base member 30 or the roof member 40, and extending from the base member 30 or the roof member 40 around the top tube 22 of the bicycle 20. The storage pouch 10 preferably includes down tube connectors 104, 106 affixed to a portion of the storage pouch 10, and extending therefrom around the down tube 26 of the bicycle 20. The storage pouch 10 preferably includes head tube connectors 100, 102 affixed to the base member 30 or the roof member 40, and extending from the base member 30 or the roof member 40 around the head tube 24 of the bicycle 20.

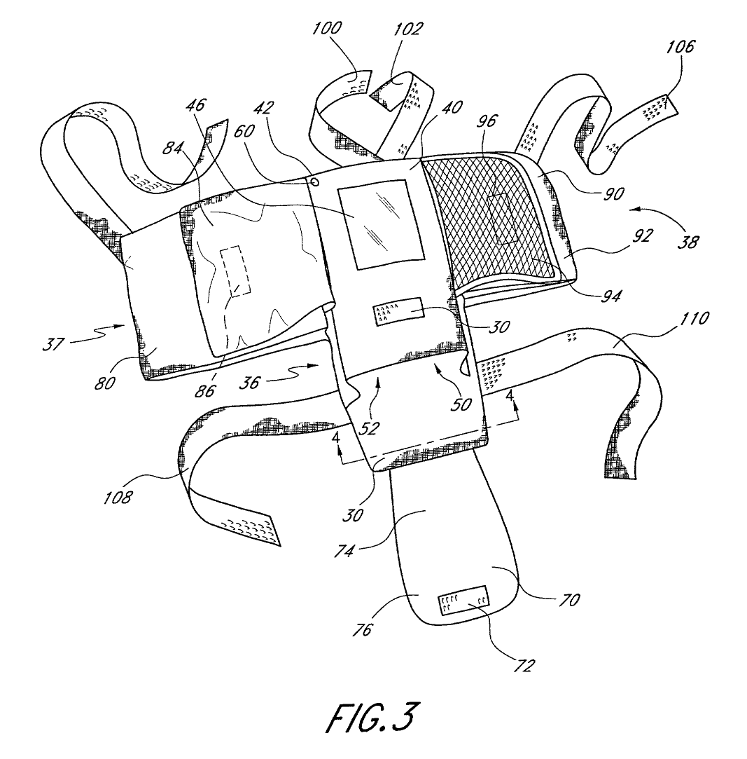

As illustrated in FIG. 3, in a preferred embodiment, the base member 30 has the approximate shape of the letter “T”, and therefore includes a middle portion 36, a first side portion 37 and a second side portion 38. As illustrated in FIG. 4, the base member 30 comprises a flexible structural member 32 enclosed in a protective covering 34. In a preferred embodiment, the flexible structural member 32 is comprised of plastic, although in other embodiments the flexible structural member 32 may be comprised of other flexible materials, such as various fabrics, cardboards, or metals. In certain embodiments, the flexible structural member 32 may include padding, thereby protecting the contents of the storage pouch 10 from mechanical shock and vibration transmitted via the top tube 22. Likewise, in a preferred embodiment, the protective covering 34 is comprised of nylon, although in other embodiments the protective covering 34 may be comprised of other suitable materials, such as various fabrics or plastics. In a preferred embodiment, the total thickness of the base member 30 is less than approximately 6.5 mm.

Referring now to FIGS. 1 through 3, in a preferred embodiment the roof member 40 has a roof member perimeter 42 defined by the outer boundary of the roof member 40. The roof member 40 has an elongated shape such that attachment of a portion of the roof member perimeter 42 to the middle portion 36 of the base member 30 forms a partially enclosed compartment 50 with an open end 52. This can be accomplished by providing the roof member 40 with a greater width than the width of the middle portion 36 of the base member 30. In a preferred embodiment, the roof member 40 is comprised of nylon, and it attached to the base member 30 by sewing. The roof member 40 is preferably shaped and sized to allow a mobile telephone to fit into the partially enclosed compartment 50 through the open end 52. For example, in one preferred embodiment, the partially enclosed compartment is approximately 130 mm long, approximately 70 mm wide and approximately 17 mm high. However, one of ordinary skill in the art will recognize that the roof member 40 may be comprised of other suitable materials, may be attached to the base member 30 using other suitable means, and may have other suitable shapes and dimensions. For example, in certain embodiments the roof member 40 and the base member 30 are comprised of a material that does not allow moisture to pass therethrough, thereby preventing moisture from reaching a mobile telephone placed within the partially enclosed compartment 50 in inclement weather.

In alternative embodiments, as illustrated in FIGS. 1 through 3, roof member 40 further comprises a roof window 46. Roof window 46 is configured to allow the display portion of a mobile telephone to be read by a cyclist without removing the mobile telephone from the partially enclosed compartment 50. This configuration provides the advantage of allowing a cyclist to view information about an incoming call with minimal interruption of cycling activities. The roof member 40 preferably comprises a flexible and transparent plastic sheath, although other transparent materials may be used in other embodiments. In other embodiments, the roof member 40 further comprises a hole 60 configured to allow the antenna of a mobile telephone to pass therethough.

As illustrated in FIGS. 1 through 3, in a preferred embodiment the fixed end 74 of roof cover 70 is hingably affixed (i.e., by sewing) to the middle portion 36 of the base member 30. The free end 76 of roof cover 70 includes a Velcro® hook or loop connector strip 72 configured to removably attach to a corresponding Velcro® loop or hook connector strip 44 affixed to the roof member 40. This configuration allows the free end 76 of the roof cover 70 to be rotated over the open end 52 of the partially enclosed compartment 50, thereby securing any contents stored therein. For example, if a mobile telephone is placed in the partially enclosed compartment 50, closing and securing the roof cover 70 over the open end 52 prevents the mobile telephone from falling out of the partially enclosed compartment 50. At the same time, however, the roof cover 70 may be easily opened and closed with one hand without causing the cyclist to divert his or her eyes from the road. In addition, by positioning the fixed end 74 of roof cover 70 as close as possible to the open end 52 of the partially enclosed compartment 50, the contents of the partially enclosed compartment 50 can be offered maximum protection from external elements, such as moisture or dust.

One of ordinary skill in the art will recognize that any other type of mechanism, such as buckles, ties or snaps, may be used to removably affix the side pouch roof members 82, 92 to the side ouch roof covers 84, 94. In a preferred embodiment, the roof cover 70 is comprised of nylon and is approximately 87 mm long and approximately 70 mm wide. However, one of ordinary skill in the art will recognize that the roof cover 70 may be comprised of other suitable materials, and may have other suitable shapes and dimensions.

Still referring to FIGS. 1 through 3, in a preferred embodiment the storage pouch 10 further comprises a first side pouch 80 and a second side pouch 90 disposed on the first side portion 37 and the second side portion 38, respectively, of the base member 30. In such embodiments, the first and second side pouches 80, 90 are formed in a similar fashion as the partially enclosed compartment 50 on the middle portion 36 of the base member. The first side pouch 80 comprises a first side pouch roof member 82 and a first side pouch roof cover 84 which is removably affixable to the first side pouch roof member 82 via Velcro® hoop and loop connector strips 86. Likewise, the second side pouch 90 comprises a second side pouch roof member 92 and a second side pouch roof cover 94 which is removably affixable to the second side pouch roof member 92 via Velcro® hoop and loop connector strips 96. However, one of ordinary skill in the art will recognize that any other type of mechanism, such as buckles, ties or snaps, may be used to removably affix the side pouch roof members 82, 92 to the side ouch roof covers 84, 94.

In certain embodiments, the first and second side pouches 80, 90 and the first and second side pouch roof members 82, 92 are comprised of a water-resistant nylon. This configuration protects the contents of the first and second side pouches 80, 90 from external inclement environmental conditions such as moisture or dust. However, in other embodiments, one or both of the first and second side pouches 80, 90 are comprised of a fabric mesh material with macroscopic apertures, thereby allowing the cyclist to view the contents of the pouches without opening the pouches. Again, this provides the advantage of allowing a cyclist to inventory the contents of the storage pouch 10 without significantly interrupting cycling activities. In other embodiments, one or both of the first and second side pouches 80, 90 are thermally insulated, thereby allowing the side pouches to be used to store items (i.e., foodstuffs or water) at reduced or elevated temperatures. In a preferred embodiment, the first and second side pouches 80, 90 are approximately 76 mm wide, approximately 100 mm long and approximately 17 mm high. The first and second side pouch roof covers 84, 94 are approximately 76 mm wide and approximately 87 mm long. Such dimensions allow the cyclist to conveniently carry many objects which are beneficial to carry during a cycling event, such as foodstuffs, car or house keys, currency, maps, or mobile telephones. Additionally, one of ordinary skill in the art will recognize that the first and second side pouches 80, 90 and the first and second side pouch roof cover 84, 94 may have other suitable shapes and dimensions.

The storage pouch 10 further comprises a plurality of connectors configured to removably attach the storage pouch 10 to a bicycle 20. FIGS. 1 through 3 illustrate a preferred configuration of such connectors. Preferably such connectors are comprised of Velcro® loop and hook connectors, although one of ordinary skill in the art will recognize that any other suitable removable attachment mechanism, such as buckles, ties or snaps, may be used with such connectors.

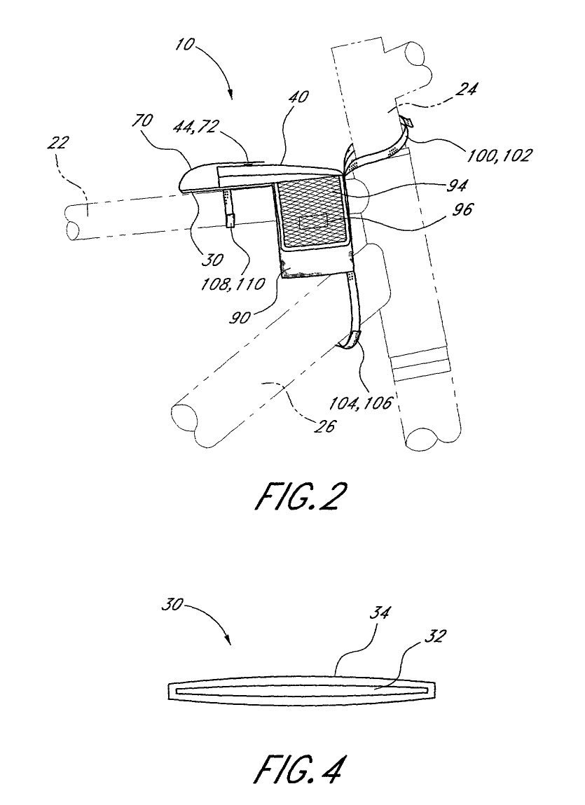

In a preferred embodiment, the storage pouch 10 further comprises head tube Velcro® loop connector 100 and head tube Velcro® hook connector 102, both of which are affixed to the base member 30 or the roof member 40. As illustrated in FIGS. 1 and 2, the head tube connectors 100, 102 are configured to be wrapped around the head tube 24 of the bicycle 20 and to be removably attached to each other, thereby securably attaching the storage pouch 10 to the bicycle 20. In a preferred embodiment, the head tube connectors 100, 102 are both approximately 100 mm long and approximately 19 mm wide, although one of ordinary skill in the art will recognize that the head tube connectors 100, 102 may have other suitable dimensions.

Similarly, in a preferred embodiment, the storage pouch 10 further comprises down tube Velcro® loop connector 104 and down tube Velcro® hook connector 106. In such embodiments, the down tube Velcro® loop connector 104 is affixed to the base member 30 or the first side pouch roof member 82. Likewise, the down tube Velcro® hook connector 106 is affixed to the base member 30 or the second side pouch roof member 92. As illustrated in FIGS. 1 and 2, the down tube connectors 104, 106 are configured to be wrapped around the down tube 26 and the top tube 22 of the bicycle 20 and to be removably attached to each other, thereby securably attaching the storage pouch 10 to the bicycle 20. In a preferred embodiment, the down tube connectors 104, 106 are both approximately 220 mm long and approximately 19 mm wide, although one of ordinary skill in the art will recognize that the down tube connectors 104, 106 may have other suitable dimensions.

Likewise, in a preferred embodiment, the storage pouch 10 further comprises top tube Velcro® loop connector 108 and top tube Velcro® hook connector 110, both of which are affixed to the base member 30 or the roof member 40. As illustrated in FIGS. 1 and 2, the top tube connectors 108, 110 are configured to be wrapped around the top tube 22 of the bicycle 20 and to be removably attached to each other, thereby securably attaching the storage pouch 10 to the bicycle 20. In a preferred embodiment, the top tube connectors 108, 110 are both approximately 140 mm long and approximately 19 mm wide, although one of ordinary skill in the art will recognize that the top tube connectors 108, 110 may have other suitable dimensions.

The connectors described above form a three-point system for connecting the storage pouch 10 the bicycle 20. This system provides the advantage of placing the storage pouch 10 well out of range of movement of the cyclist's knees during the pedaling cycle, thereby preventing interruptions of the cyclist's pace and cadence. In addition, by strapping the storage pouch to both the top tube 22 and the down tube 26, the first and second side pouches 80, 90 are drawn in toward the center axis of the bicycle 20, thereby “hiding” a significant portion of such pouches in the wind shadow created by the head tube 24. This serves to minimize detrimental effects caused by the storage pouch 10 on the wind resistance of the bicycle 20. Finally, because the three-point attachment system secures the storage pouch 10 to three different tubes of the bicycle, the storage pouch 10 is not susceptible to becoming loose and twisting or falling out of its intended position on the top tube 22 (as illustrated in FIGS. 1 and 2).

### Scope of the Invention

The foregoing presents a description of certain preferred embodiments of a storage pouch, and of the manner and process of making and using it, in such full, clear, concise and exact terms as to enable any person of ordinary skill in the art to which it pertains to make and use such a storage pouch. This storage pouch is, however, susceptible to modifications and alternate constructions from that discussed above which are fully equivalent. Consequently, it is not the intention to limit this storage pouch to the particular embodiments disclosed herein. On the contrary, the intention is to cover all modifications and alternate constructions coming within the spirit and scope of the storage pouch as generally expressed by the following claims, which particularly point out and distinctly claim the subject matter of the storage pouch.

What is claimed is:

1. A storage pouch configured to be removably attached to a top tube, a head tube and a down tube of a bicycle, the storage pouch comprising:
a base member having a center portion and at least one side portion,
a roof member having a roof member perimeter, a portion of the roof member perimeter attached to the center portion of the base member, such that a top partially enclosed compartment having a top compartment opening is formed between the center portion of the base member and the roof member,
a top tube connector affixed to the base member or the roof member, the top tube connector extending from the base member or the roof member around the top tube of the bicycle,
a down tube connector affixed to a portion of the storage pouch and extending therefrom around the down tube of the bicycle, and
a head tube connector affixed to the base member or the roof member, the head tube connector extending from the base member or the roof member around the head tube of the bicycle.

2. The storage pouch of claim 1, wherein the base member further comprises a flexible structural member enclosed within a protective covering.

3. The storage pouch of claim 1, further comprising a roof cover configured to cover at least a portion of the top compartment opening.

4. The storage pouch of claim 3, wherein the roof cover is removably attachable to the roof member.

5. The storage pouch of claim 1, further comprising:
at least one side roof member having a side roof member perimeter attached to the side portion of the base member, such that at least one side partially enclosed compartment having a side compartment opening is formed between the side portion of the base member and the side roof member.

6. The storage pouch of claim 5, further comprising a side roof cover configured to cover at least a portion of the side compartment opening.

7. The storage pouch of claim 6, wherein the side roof cover is removably attachable to the side roof member.

8. The storage pouch of claim 6, wherein the side roof cover comprises a mesh such that a bicycle rider can see into the side partially enclosed compartment without opening the side partially enclosed compartment.

9. The storage pouch of claim 1, wherein the roof member further comprises a transparent portion configured to permit a bicycle rider to see into the top partially enclosed compartment without opening the top partially enclosed compartment.

10. The storage pouch of claim 1, wherein the roof member is attached to the base member via sewing.

11. The storage pouch of claim 1, wherein the top tube connector, the head tube connector, and the down tube connector further comprises first and second elongated strips of hook and loop connector material.

12. A method of receiving an incoming telephone call on a mobile telephone comprising:
positioning the mobile telephone within a storage pouch secured to a bicycle, the storage pouch having a transparent window configured to allow a display portion of the mobile telephone to be viewed by a bicycle rider without removing the mobile telephone from the storage pouch,
viewing the display portion of the mobile telephone upon receipt of the incoming telephone call, and
deciding whether to answer the incoming telephone call based upon information gleaned from viewing the display portion of the mobile telephone.

13. The method of claim 12, further comprising:
opening a protective cover of the storage pouch,
removing the mobile telephone from the storage pouch, and
answering the incoming telephone call.

14. The method of claim 13, further comprising:
returning the mobile telephone to the storage pouch after answering the incoming telephone call, and
resealing the protective cover of the storage pouch.

15. A multifunction pouch comprising:
a horizontal storage compartment positioned atop a top tube of a bicycle, the horizontal storage compartment having an opening,
at least one vertical storage compartment connected to the horizontal storage compartment, the vertical storage compartment positioned aside the top tube of the bicycle, the vertical storage compartment having an opening, and
at least two connectors securing the horizontal and vertical pouches to the bicycle.

16. The multifunction pouch of claim 15, further comprising at least one cover configured to enclose one of the horizontal or vertical storage compartments.

17. The multifunction pouch of claim 16, wherein the at least one cover comprises a mesh such that a bicycle rider can see into the horizontal or vertical storage compartment without opening the horizontal or vertical storage compartment.

18. The multifunction pouch of claim 15, wherein the horizontal storage compartment further comprises a transparent portion configured to permit a bicycle rider to see into the horizontal storage compartment without opening the horizontal storage compartment.

19. The multifunction pouch of claim 15, wherein the connectors are affixed to the multifunction pouch via sewing.

20. The storage pouch of claim 15, wherein each of the connectors further comprises first and second elongated strips of hook and loop connector material.
